(19) United States
(12) Patent Application Publication
(10) Pub. No.: US 2019/0373952 A1
(43) Pub. Date: Dec. 12, 2019

(54) Portable Vaporizer Device with Integrated Multi-Port Charging System

(71) Applicants: Lucas Michael Todd, Mill Valley, CA (US); Zachary Roy Sokol, Brooklyn, NY (US); Eli Henry Libman, Mount Royal (CA)

(72) Inventors: Lucas Michael Todd, Mill Valley, CA (US); Zachary Roy Sokol, Brooklyn, NY (US); Eli Henry Libman, Mount Royal (CA)

(21) Appl. No.: 16/412,703

(22) Filed: May 15, 2019

Related U.S. Application Data
(60) Provisional application No. 62/671,953, filed on May 15, 2018.

(51) Int. Cl. A24F 47/00; H02J 7/00

(52) U.S. Cl. CPC A24F 47/008; H02J 2007/0062; H02J 7/0045; H02J 7/0052

(57) ABSTRACT

Portable vaporizer with integrated charging unit that may have multiple different connectors for different devices; including but not limited to, mobile devices such as smartphones, tablets, notebook computers, and other devices utilizing USB (Universal Serial Bus) “OTG” (On-the-Go) protocol. The internal charging unit and battery in one embodiment of this invention may be intended to receive charge from all devices that are able to provide power from a “female” power port such as USB Type A, Type Micro-B, Lightning, Type C, etc. This device may improve the current or conventional vaporizers and E-cigarettes by integrating the charging unit and battery into the body of the device and providing flexibility to the user with regard to what power source may be available to recharge the internal battery.

### TECHNICAL FIELD

This invention relates to a portable electronic vaporizer, in particular to a design which includes an internal battery and charging unit that possesses the ability to charge from a mobile phone as well as a myriad of other portable electronic devices. The charging system in traditional vaporizers and e-cigarettes is inelegant and inflexible with respect to the reliance upon a separate, outboard charging unit and lack of flexibility with the type of power supply that is able to recharge the internal battery. One embodiment of this new invention provides maximum utility to the user by integrating the charging unit into the body of the device, as well as providing multiple options with respect to the type of “Host” device that may be used to recharge the internal battery of the vaporizer device.

### BACKGROUND

Current vaporizers and e-cigarettes on the market provide a safer alternative to smoking. By nature, these products need to provide the convenience of use anywhere and anytime. However, conventional vaporizers currently on the market are inelegant and inflexible with respect to the reliance upon a separate, outboard charging unit, and also lack flexibility and mobility with regards to the power sources that can be used to charge the battery. Conventional vaporizers and e-cigarettes require outboard charging units. Conventional vaporizers typically come with separate charging units that either plug into a wall outlet or the USB-A hub of power adaptors and personal computers. The most recent advancements in battery technology have made mobile devices including smartphones, tablets, and laptops viable charging platforms for powering and charging peripheral electronics. One embodiment of this invention offers not only a built-in charger eliminating the necessity of an outboard charging unit, but the option to charge from the “female” port of multiple devices, including smartphones and tablets.

### SUMMARY OF THE INVENTION

The invention aims at improving upon current e-cigarettes and vaporizers by providing a more convenient built-in, flexible USB OTG-enabled charging system that maximizes portability without the need for a separate outboard charging unit, as well as the ability to charge from numerous portable electronic devices, including popular smartphones, tablets, and personal computers. Additionally, the device may have an elegant, compact, and convenient design. The electronic vaporizer, in accordance with certain aspects of the invention, may be comprised of five major components: a connector pin barrel component (to connect with the atomizer of a vaporizer cartridge), an onboard charging unit component, a rechargeable battery component, an activation switch/mechanism, and a power jack assembly.

The connector component is the mechanical connection that allows current to flow from the battery to the atomizer part of the vaporizer cartridge.

The onboard charging unit component may include three “male” power input jacks (USB A, Lightning, or USB-C). The built-in battery charger circuit may be able to provide power to the atomizer connector even while charging the battery. An exemplary onboard DC/DC boost converter module located within the charging circuit may be powered by a 3.7 V LiIon/LiPoly battery and may convert the battery output to 5.2 V DC for supplying power to an atomizer connector. The preferred boost converter circuit may provide low battery detection, a 2-Amp internal switch, synchronous conversion, high efficiency, and 700 kHz high-frequency operation for rapid charging capability. A 2 amp internal switch may allow an output of 500 mA(+) from a 3.7 V LiIon/LiPoly battery.

The battery component comprises a protective battery sleeve, a rechargeable battery within, and connectivity to the internal battery charging unit. The battery size and capacity are variable.

The switch mechanism may engage the connection from the battery to the connector pin, thus supplying power to the atomizer.

The power jack assembly may be comprised of a sliding mechanism that reveals each power jack that is normally obscured within the body of the device.

### BRIEF DESCRIPTION OF THE DRAWINGS

FIG. 1 shows a top view of the Portable Vaporizer Device connected to the charging port of a mobile device.

FIG. 2 shows a perspective view of the Portable Vaporizer Device connected to the charging port of a mobile device without a mouthpiece installed.

FIG. 3 shows a perspective view of the Portable Vaporizer Device connected to the charging port of a mobile device with a mouthpiece installed.

FIG. 4 shows a perspective view of the Portable Vaporizer Device with one of three charging options selected with the corresponding slider on the left side.

FIG. 5 shows a perspective view of the Portable Vaporizer Device with one of three charging options selected with the corresponding slider on the left side.

FIG. 6 shows a perspective view of the Portable Vaporizer Device with one of three charging options selected with the corresponding slider on the left side.

FIG. 7 shows a side view of the Portable Vaporizer Device with three charging options, 2, 3, 4, and the corresponding sliders on the left side, 1.

FIG. 8 is a drawing showing some of the mechanical components of the device.

FIG. 9 is a basic diagram of some the electronic components of the device.

FIG. 10 is an electronic schematic of the preferred charging unit circuitry.

FIG. 11 shows a working prototype of the Portable Vaporizer Device.

FIG. 12 shows a top view of the Portable Vaporizer Device with the mouthpiece installed.

### DETAILED DESCRIPTION OF THE DRAWINGS

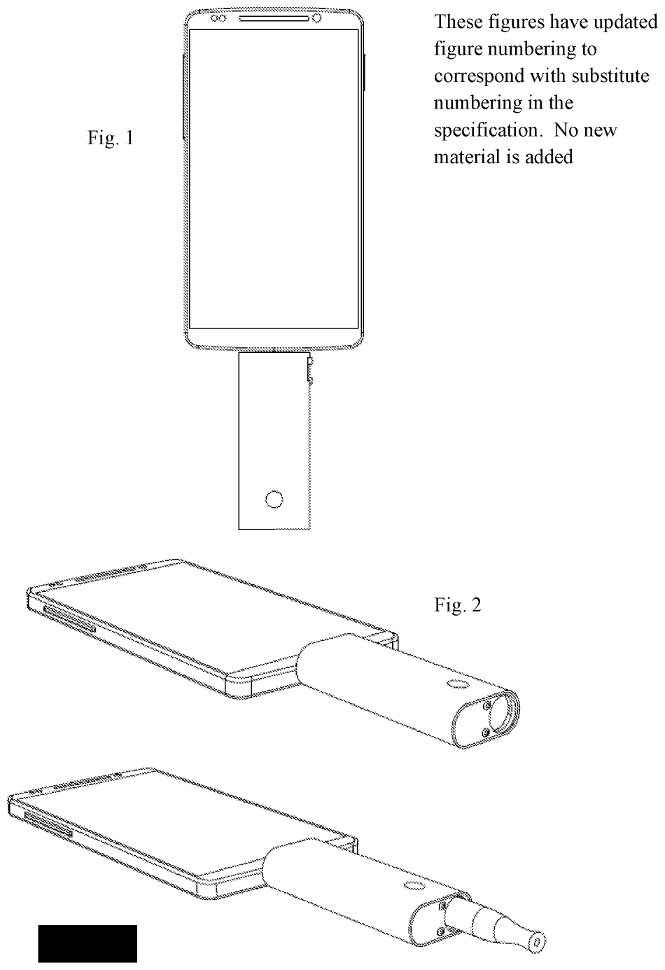

FIGS. 1, 2 and 3 demonstrate the device charging from a smartphone, which may include a Lightning connector.

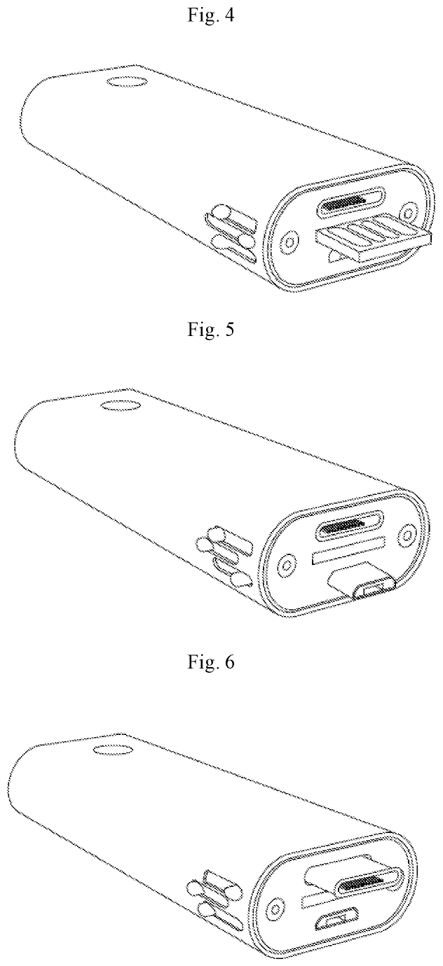

FIGS. 4, 5, and 6 exhibit an assortment of male power connector(s) and sliding mechanism used to protrude the connector(s) and retract them into the device. In the example design, we will use the following power connectors (however, any number or combination of male power connectors could be used), for example 2.1 USB TYPE A, 2.2 LIGHTNING, or 2.3 USB TYPE C.

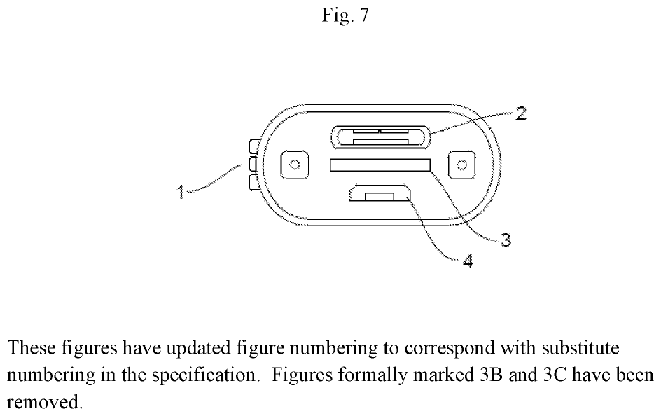

FIG. 7 is the preferred body shape design of the device

Item 1 shows the sliding mechanism that protrudes and retracts male power connectors

Items 2, 3, and 4 show connectors for different mobile devices/power sources

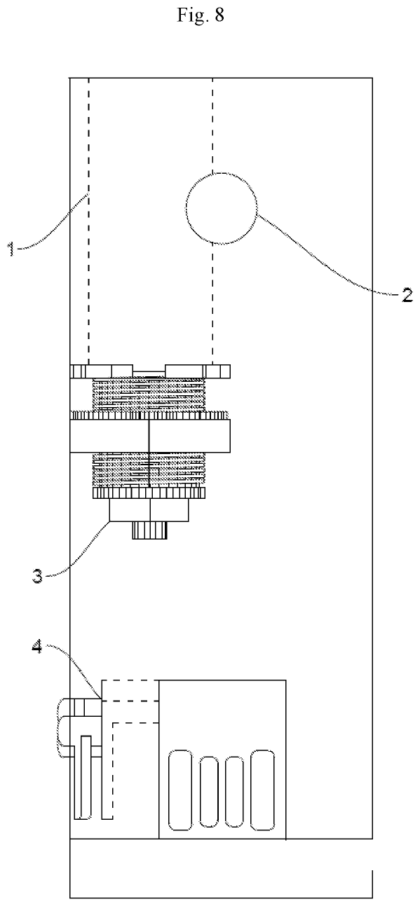

FIG. 8 depicts the preferred mechanical components of the device.

Item 1 shows a cylindrical void within the device allows an atomizer to sit recessed in the body.

Item 2 shows a switch for activating and changing settings the device.

Item 3 shows a connector pin.

Item 4 shows a sliding mechanism for protruding jack(s) and retracting them into the body of the device.

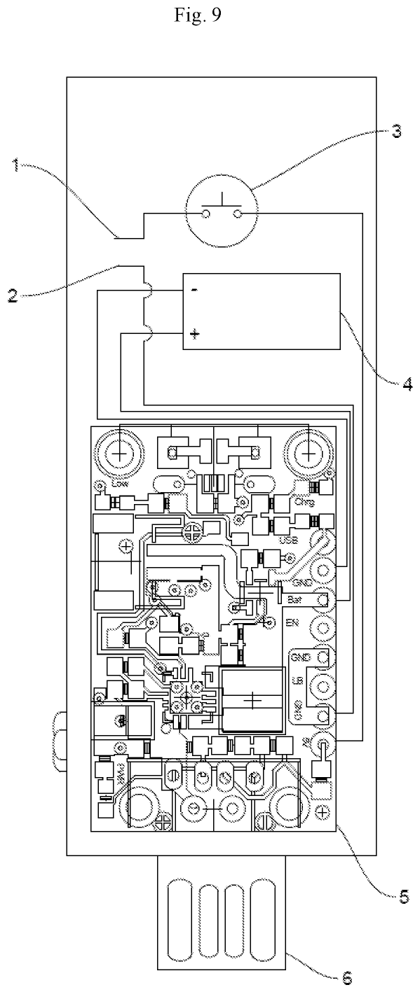

FIG. 9 is an overview schematic of the preferred electronic components of the device

Item 1 shows a positive wire that connects to the positive terminal of the connector pin

Item 2 shows a ground wire that connects to the negative terminal of the connector pin

Item 3 shows a switch that completes the connection from the board to the connector pin

Item 4 shows an internal battery (for example, a 3.7V LiPoly/LiIon battery)

Item 5 shows a PCB board of the internal battery charging unit

Item 6 shows one of the possible USB jacks that supplies power to the board

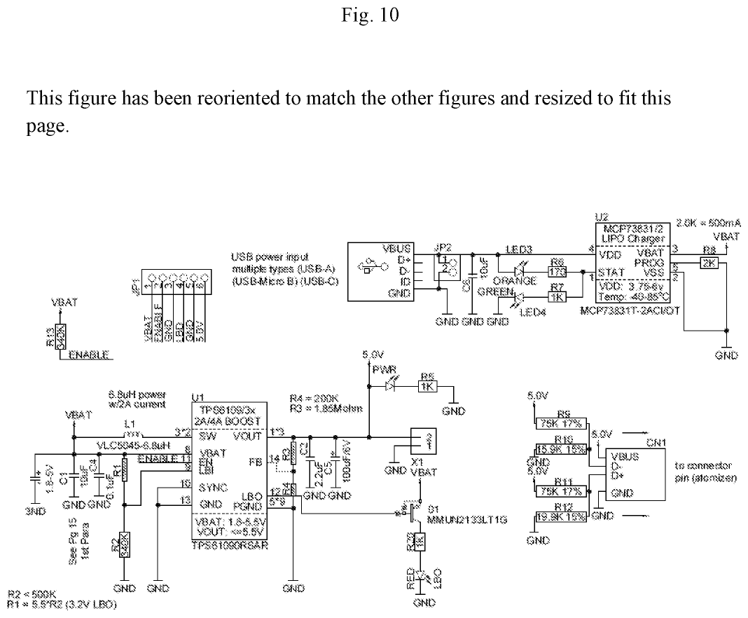

FIG. 10 is a schematic of the circuit and preferred electrical components that comprise the onboard charging unit.

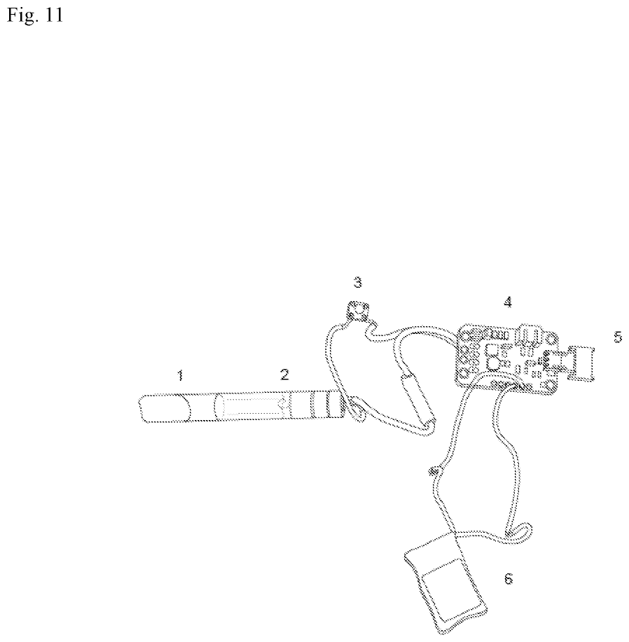

FIG. 11 the components of a working prototype built by the inventor

Item 1 shows an atomizer cartridge

Item 2 shows a connector pin for 510 thread vaporizer cartridges

Item 3 shows a momentary switch

Item 4 shows an onboard charging board

Item 5 shows a USB-A connector

Item 6 shows a 3.7 V LiPoly/LiIon battery

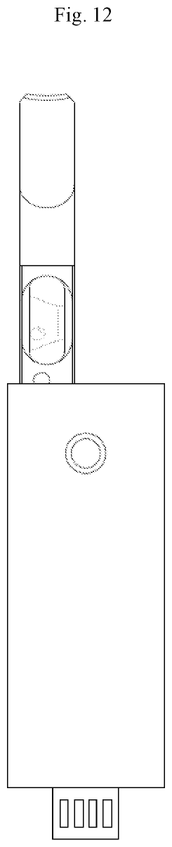

FIG. 12 shows a top view of the entire device with the mouthpiece installed at the top, and a charging port protruded at the bottom.

1. A device comprising an integrated charging unit and a rechargeable battery within the body of the device that enables charging from a mobile device such as a smartphone, tablet, or laptop using a USB OTG protocol.

2. A portable vaporizer device comprising an integrated charging unit and a rechargeable battery within the body of the vaporizer that enables charging from a mobile device such as a smartphone, tablet, or laptop using a USB OTG protocol or other similar means.

3. The portable vaporizer device of claim 2, further comprising a plurality of USB receptacles to accommodate various devices that may recharge the rechargeable battery.

4. The portable vaporizer device of claim 3, further comprising a sliding mechanism to reveal at least one of the USB receptacles.

5. The portable vaporizer device of claim 4, further comprising an ultra-compact design.

6. A portable vaporizer device comprising an integrated charging unit and a rechargeable battery within the body of the device that permits charging from a power source such as a smartphone, tablet, or laptop using a USB OTG protocol or other similar means; a plurality of USB receptacles disposed at an end of the device to accommodate various mobile devices that may recharge the rechargeable battery; and a sliding mechanism to reveal at least one USB receptacle within the body of the e-cigarette.

7. The portable vaporizer device of claim 6, further comprising an ultra-compact design.
